(19) United States
(12) Patent Application Publication
(10) Pub. No.: US 2026/0203871 A1
(43) Pub. Date: Jul. 16, 2026

(54) NEURAL DENOISING OF PATH TRACED IMAGES WITH SCREEN SPACE EFFECTS

(71) Applicant: NVIDIA Corporation, Santa Clara, CA (US)

(72) Inventors: Pekka Markus JÄNIS, Espoo (FI); Jussi Tuomas RÄSÄNEN, Helsinki (FI); Pietari Armas KASKELA, Helsinki (FI); Juho MARTTILA, Espoo (FI); Shiqiu LIU, Santa Clara, CA (US)

(73) Assignee: NVIDIA Corporation, Santa Clara, CA (US)

(21) Appl. No.: 19/020,928

(22) Filed: Jan. 14, 2025

(51) Int. Cl. G06T 5/70; G06T 5/50; G06T 15/06

(52) U.S. Cl. CPC G06T 5/70; G06T 5/50; G06T 15/06

(57) ABSTRACT

In various examples, one or more processors can include one or more circuits to obtain an image generated by executing path tracing operations. The one or more circuits can apply an effect to the image in two-dimensional screen space and can update the image to represent a difference between the original image and the image, with the effect applied to improve downstream denoising of the image. The updated image can then be provided to a denoiser that implements one or more neural networks that are trained/updated to output a final image that is denoised and displayed using a display device.

### BACKGROUND

In real-time rendering of path-traced images, such as in computer graphics, denoisers are often used to remove noise from the inherent randomness involved in sampling light paths. These denoisers can filter both spatial and temporal noise introduced by the image generation process. But when effects such as subsurface scatter and refraction effects are modeled in screen space (using the image resulting from the execution of path-tracing), additional noise can be introduced that is correlated across a plurality of pixels. For example, when a blur is applied to the path-traced image to soften the effects of lighting in the scene and to create the appearance of realistic diffusion of the light within the scene, introduction of the blur can cause the pixels surrounding the noisy pixels to likewise be diffused, which can degrade the quality of the affected pixels and resulting rendered image by extension.

### SUMMARY

Embodiments of the present disclosure relate to denoising of path traced images with screen space effects. For example, systems and methods are disclosed that allow for neural denoising of path traced images with screen space effects.

As noise is diffused throughout an image, it can be difficult for denoisers to remove both the earlier-introduced noise, as well as the correlated noise attributable to these effects. As a result, “noise passthrough” is often observed, where the noise originally introduced is mistaken for features in the image and carried through to the final image. While approaches can be implemented to address this noise passthrough by breaking or reducing spatial correlations, these approaches can slow down image convergence and subdue the originally-applied effect. These approaches can also require significantly more processing and memory resources to maintain the same output image quality to achieve real-time operation without accepting image degradation.

The present disclosure addresses the above-noted difficulties and describes the implementation of a guide buffer to the image generation process that adds at least one additional channel to the path-traced images before being processed by a denoiser (e.g., encoder/decoder-based denoisers, transformer-based denoisers, etc.). More specifically, systems are described that can obtain image data when performing path tracing operations. The systems can then apply an effect(s) to the image (e.g., subsurface scatter, refraction, heat distortion, chromatic aberration, depth of field, bloom). The difference between the image without and with the effect(s) can then be calculated and a third image determined (e.g., stored in the guide buffer). This third image can then be used during the denoising process.

In contrast to conventional systems, the techniques described herein allow for more precise targeting of noise introduced when applying screen space effects. For example, by implementing the techniques described, existing image generation pipelines can be adapted, such that deviations in pixel values indicative of correlated noise can be identified before executing a denoiser. This can reduce or eliminate noise passthrough that would otherwise be mistaken as image features and not addressed by the denoiser. Further, the techniques described can reduce or eliminate the need to implement techniques, such as stochastic sampling, that would require the dedication of significant computational resources (e.g., processing cycles and memory) when solving complex integrals during the sampling process.

At least one aspect relates to one or more processors. The one or more processors can include one or more circuits to obtain first image data for an image generated in accordance with one or more path tracing operations. The one or more circuits can generate second image data for the image by executing one or more operations to apply an effect to the image. In some implementations, the one or more circuits can generate third image data based at least on a difference between the first image data and the second image data. The one or more circuits can execute one or more operations to remove noise from the second image data based at least on the second image data and the third image data.

In some aspects, the one or more path tracing operations can include sampling light paths in a scene from a camera through to a light source. In some implementations, to obtain the first image data, the one or more circuits can obtain the first image data in response to sampling of the light paths in the scene. The first image data can be associated with an amount of noise introduced by the sampling. In some aspects, the image can include a two-dimensional image. To generate the second image data, the one or more circuits can execute the one or more operations to the image to apply a screen space effect to the image. In aspects, the one or more circuits can establish a guide buffer based at least on the first image data and the second image data. The guide buffer can include one or more values representing the difference between the first image data and the second image data.

In some aspects, to establish the guide buffer, the one or more circuits can determine the values representing the difference between the first image data and the second image data, based at least on a channel of the image corresponding to luminance of pixels of the image. To generate third image data, the one or more circuits can update the second image data by concatenating the values in the guide buffer, as one or more additional channels to generate the third image data. In some implementations, the one or more circuits to execute the one or more operations to remove noise from the second image data can generate input data based at least on the second image data and the third image data. In some implementations, the one or more circuits can provide the input data to an encoder to generate output data, including an embedding that represents the second image data and the third image data. The one or more circuits can provide the output data to a decoder to generate a final image.

At least one aspect relates to a system. The system can include one or more processors. The one or more processors can perform operations, including executing one or more operations to apply a screen space effect to first image data for an image generated in accordance with one or more path tracing operations to obtain second image data for the image. The one or more operations can include generating third image data based at least on a difference between the first image data and the second image data. The one or more operations can include executing one or more operations to remove noise from the second image data based at least on the second image data and the third image data.

In some aspects, the one or more path tracing operations can include sampling light paths in a scene from a virtual viewpoint/camera position through to a light source. In some implementations, to obtain the first image data, the one or more processors can obtain the first image data in response to sampling of the light paths in the scene. The first image data can be associated with an amount of noise introduced by the sampling. In aspects, the image can include a two-dimensional image. To generate the second image data, the one or more processors can execute the one or more operations to the image to apply a screen space effect to the image. The screen space effect can include at least one of subsurface scatter, refraction, heat distortion, chromatic aberration, depth of field, or bloom. In some implementations, the one or more processors can establish a guide buffer based at least on the first image data and the second image data. The guide buffer can include values representing the difference between the first image data and the second image data.

In aspects, to establish the guide buffer, the one or more processors can determine the values representing the difference between the first image data and the second image data, based at least on a channel of the image corresponding to luminance of pixels of the image. In some implementations, to generate third image data, the one or more processors can update the second image data by concatenating the values in the guide buffer as one or more additional channels to generate the third image data. In at least some aspects, to execute the one or more operations to remove noise from the second image data, the one or more processors can generate input data based at least on the second image data and the third image data. The one or more processors can provide the input data to an encoder to generate output data including an embedding that represents the second image data and the third image data and provide the output data to a decoder to generate a final image.

At least one aspect relates to a method. The method can include obtaining first image data for an image generated in accordance with one or more path tracing operations. In some implementations, the method can include generating second image data for the image by executing one or more operations to apply an effect to the image. In at least some implementations, the method can include generating third image data, based at least on a difference between the first image data and the second image data. In implementations, the method can include executing one or more operations to remove noise from the second image data based at least on the second image data and the third image data.

In some aspects, the one or more path tracing operations can include sampling light paths in a scene from a camera through to a light source, and obtaining the first image data can include obtain the first image data in response to sampling of the light paths in the scene. The first image data can be associated with an amount of noise introduced by the sampling. In some implementations, the image can include a two-dimensional image, and generating the second image data can include executing the one or more operations to the image to apply a screen space effect to the image. In at least some implementations, the method can further include establishing a guide buffer, based at least on the first image data and the second image data. The guide buffer can include values representing the difference between the first image data and the second image data.

In some aspects, one or more of the system or the one or more processors can be included in, or the method implemented using, at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more small language models (SLMs); a system implementing one or more large language models (LLMs); a system for implementing multi-modal language models (MMLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

### BRIEF DESCRIPTION OF THE DRAWINGS

The present systems and methods for noise reduction in computer generated images are described in detail below with reference to the attached drawing figures, wherein:

FIG. 1 is an example environment in which one or more devices operate to denoise path traced images with screen space effects, in accordance with some embodiments of the present disclosure;

FIG. 2 is an example implementation of a workflow for denoising of path traced images with screen space effects, in accordance with some embodiments of the present disclosure;

FIG. 3 is a flow diagram of a method for denoising of path traced images with screen space effects, in accordance with some embodiments of the present disclosure;

FIG. 4A is a block diagram of an example generative language model system suitable for use in implementing some embodiments of the present disclosure;

FIG. 4B is a block diagram of an example generative language model that includes a transformer encoder-decoder suitable for use in implementing some embodiments of the present disclosure;

FIG. 4C is a block diagram of an example generative language model that includes a decoder-only transformer architecture suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to neural denoising of path traced images with screen space effects. For example, systems described herein can include one or more processors that include one or more circuits configured to denoise images, such as path traced images with screen space effects, using one or more neural networks.

In real-time rendering of path traced images for applications like computer applications, denoisers can be used to apply updates to path traced images that improve image quality (which can be degraded due to a limited number of rays or paths that can be computed per pixel on some resource-constrained computing devices). For example, denoisers can be configured to remove noise through spatial and temporal filtering. While ray tracing can be used for most light transport simulation, practical considerations can involve the implementation of traditional screen space methods for certain effects like subsurface scattering and refraction. For example, a rendering pipeline can involve generating a path traced image (e.g., a noisy color buffer) using a combination of rasterization and ray tracing techniques, applying screen space effects, and then denoising and compositing the result into a final image. However, when screen space functions are applied to the noisy color buffer, they can introduce correlations to the noise, complicating the denoising process. As a result, denoisers that are based at least on neural network architectures, which can be configured to classify patterns as either noise or intended features, can mistakenly interpret correlated noise as features, leading to unsatisfactory “noise passthrough” in the final output. And approaches like stochastically sampling blur kernels to reduce spatial correlations have some drawbacks, potentially subduing the desired effect in the final image.

The present disclosure addresses the challenges associated with identifying and addressing the diffusion of noise across an image inherent to the path tracing process by detailing the implementation of a guide buffer within the image generation process. This guide buffer can add at least one additional channel to the path-traced images prior to their processing by a denoiser (e.g., encoder/decoder-based denoisers, transformer-based denoisers, etc.). Specifically, the systems described herein can acquire image data during path tracing operations and can subsequently apply an effect(s) to the image. Primary examples of such effects include subsurface scatter, refraction, heat distortion, chromatic aberration, depth of field, and bloom. The difference between the unaltered image and the image with the applied effect(s) can be computed, resulting in a third image, which is stored in the guide buffer. This third image can then be utilized in the denoising process.

Compared to conventional systems, the techniques described herein allow for more accurate targeting of noise that arises when applying screen space effects. By using these techniques, existing image generation pipelines can be adapted so that deviations in pixel values indicative of correlated noise can be identified before executing a denoiser. This approach helps reduce or eliminate noise passthrough that would otherwise go undetected by the denoiser. Additionally, these techniques can minimize or eliminate the need for methods such as stochastic sampling, which require significant computational resources.

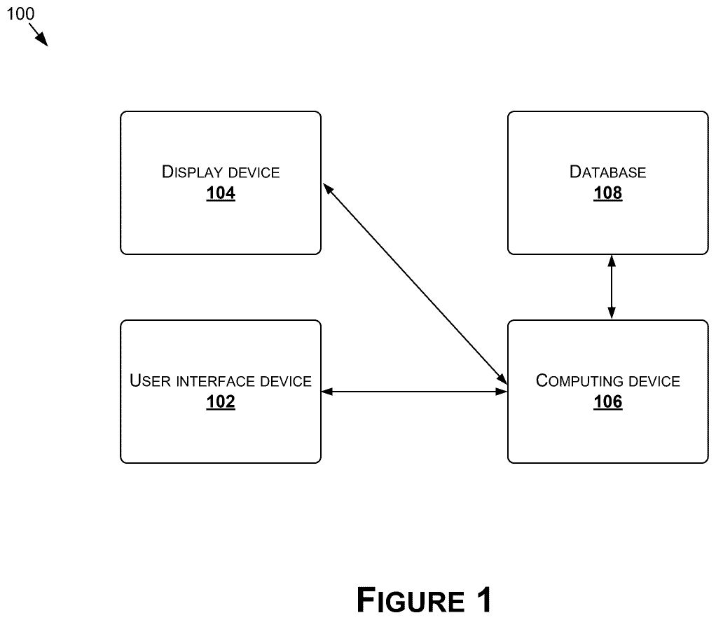

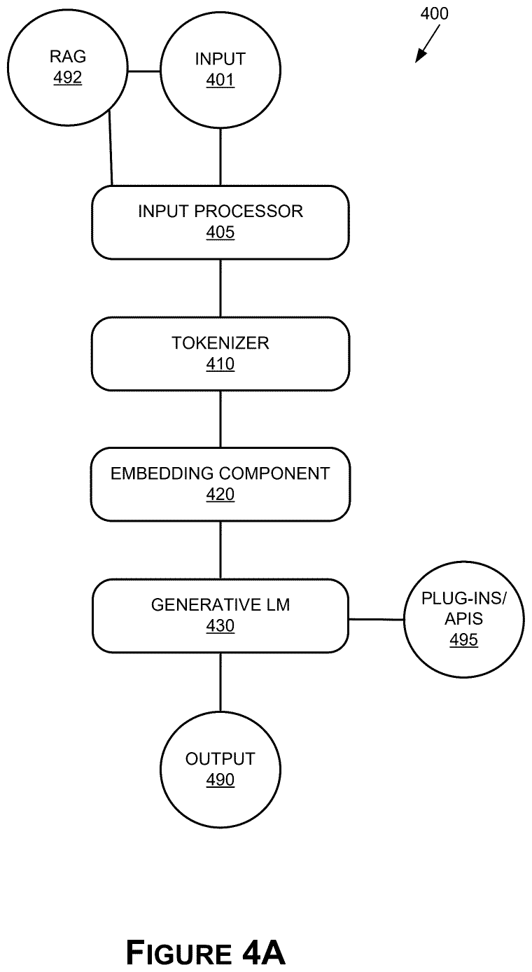

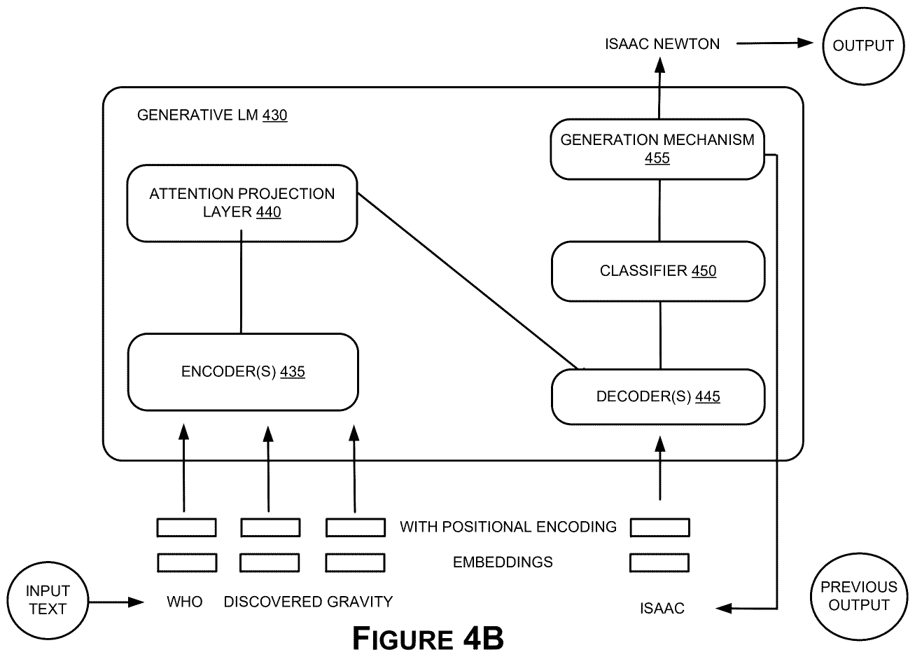

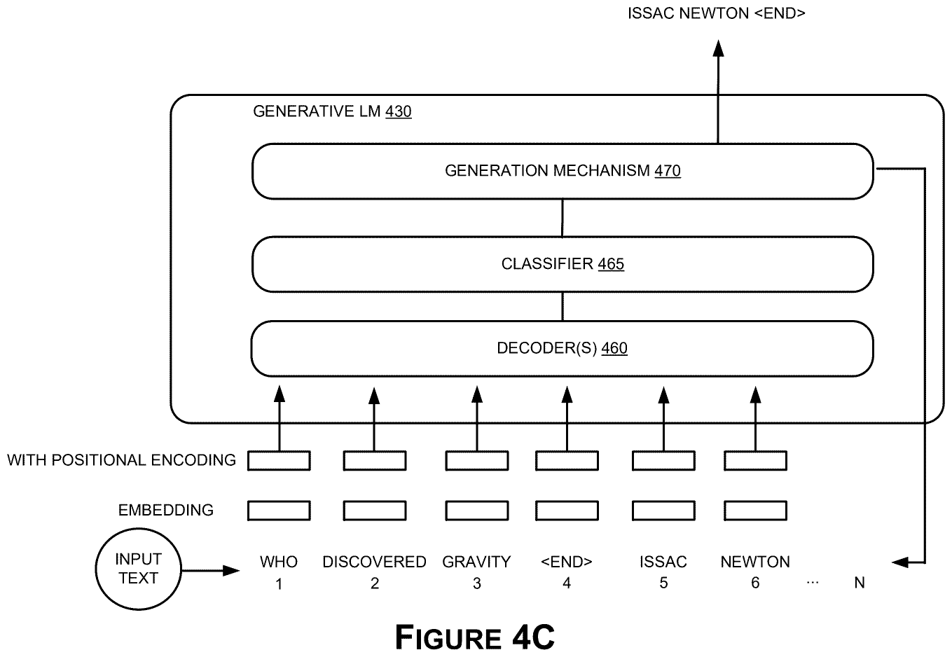

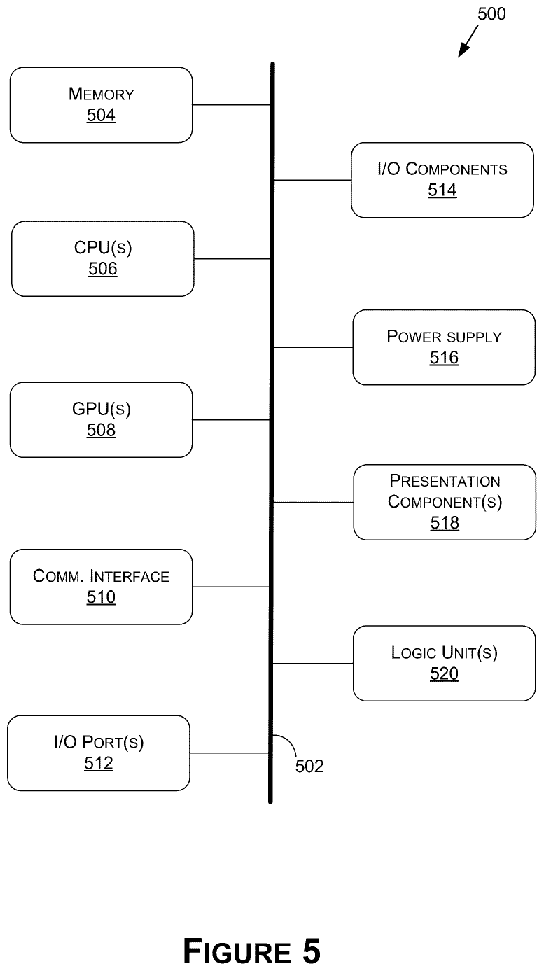

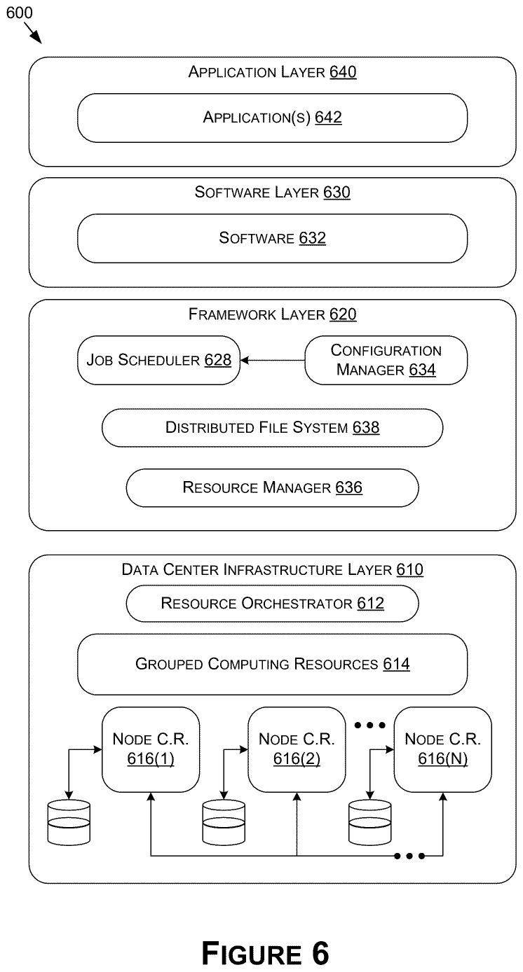

With reference to FIG. 1, FIG. 1 is an example environment 100, in which one or more devices operate to denoise path traced images with screen space effects, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory. For example, in some embodiments, the system and methods described herein can be implemented using one or more generative language models (e.g., as described in FIGS. 4A-4C), one or more computing devices (e.g., as described in FIG. 5), and/or one or more data centers (e.g., as described in FIG. 6).

The environment 100 includes a user interface device 102, a display device 104, a computing device 106, and/or a database 108. In some embodiments, the user interface device 102, the display device 104, the computing device 106, and/or the database 108 can include one or more components that are the same as, or similar to, one or more components of the computing device as described in FIG. 5. In some embodiments, one or more of the devices of FIG. 1 can interconnect using one or more wired and/or wireless connections, such interconnections corresponding to one or more networks as described herein.

In some embodiments, the user interface device 102 can include one or more devices configured to be in communication with the computing device 106. For example, the user interface device 102 can include one or more devices configured to be in wired and/or wireless communication with the computing device 106, thereby establishing wired and/or wireless communication connections with the computing device 106. In some embodiments, the user interface device 102 can include a device that is configured to be manipulated by an individual and can generate signals representing such manipulation by the individual. The user interface device 102 can then transmit the signals to the computing device 106 using the one or more wired and/or wireless communication connections. In some embodiments, the user interface device can include one or more of: a keyboard, a mouse, a joystick, and/or the like.

In some embodiments, the display device 104 can include one or more devices configured to be in communication with the computing device 106. For example, the display device 104 can include one or more devices configured to be in wired and/or wireless communication with the computing device 106, thereby establishing wired and/or wireless communication connections with the computing device 106. In some embodiments, the display device 104 can include a device that is configured to output one or more images generated by the computing device 106. For example, the display device 104 can include a device such as a computer monitor, a touchscreen, a mobile device display (e.g., a smartphone display), and/or the like.

In some embodiments, the computing device 106 can include one or more devices configured to be in communication with the user interface device 102, the display device 104, and/or the database 108. For example, the computing device 106 can include one or more devices configured to be in wired and/or wireless communication with the user interface device 102, the display device 104, and/or the database 108, thereby establishing wired and/or wireless communication connections with the computing device 106. In some embodiments, the computing device 106 can include a device that is configured to generate data associated with one or more images, the data associated with the one or more images configured to cause the display device 104 to display the one or more images. For example, the computing device 106 can include a device such as a mobile device (e.g., smartphone), a laptop, a desktop, a server, and/or the like.

In some embodiments, the database 108 can include one or more devices configured to be in communication with the computing device 106. For example, the database 108 can include one or more devices configured to be in wired and/or wireless communication with the computing device 106, thereby establishing wired and/or wireless communication connections with the computing device 106. In some embodiments, the database 108 can include a device that is configured to store data described herein such as, for example, data associated with a scene, data associated with one or more images, and/or the like. For example, the database 108 can include a device such as a memory as described herein.

With continued reference to FIG. 1, in some embodiments, the environment 100, can be used to generate path-traced images with screen space effects. For example, the devices of the environment 100 (e.g., a user interface device 102, a display device 104, a computing device 106, and a database 108) can coordinate when executing a workflow to generate, denoise, and display path traced images. In some examples, the user interface device 102 can receive inputs and commands that guide the path tracing process. For example, the user interface device 102 can include peripherals such as keyboards, mice, or touchscreens, etc., that allow individuals (e.g., users) to manipulate the rendering parameters and view the results in real-time. The display device 104 can then obtain image data generated and generate (e.g., output) the image thereon.

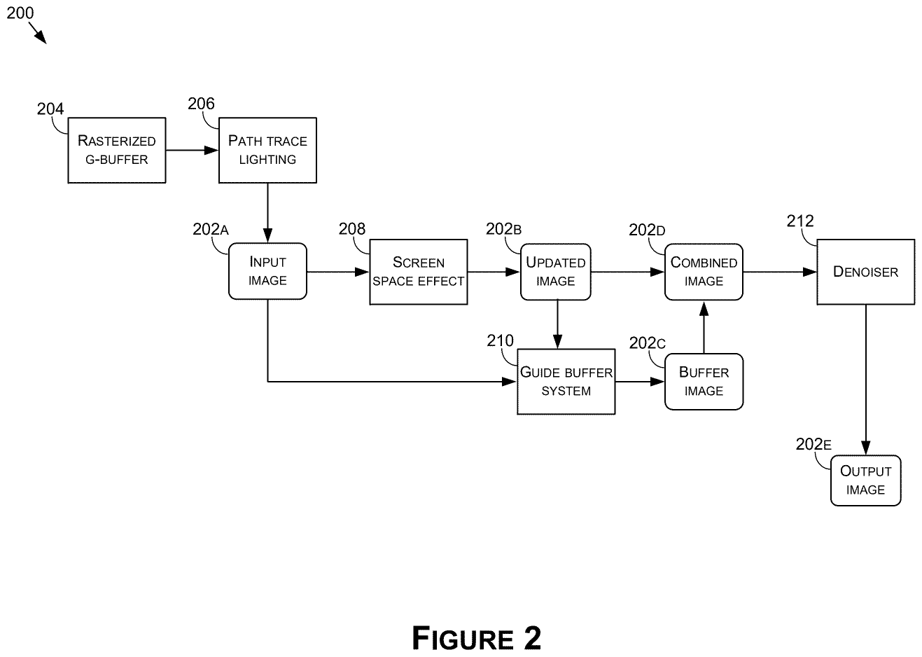

The computing device 106 can execute one or more operations when generating path traced images such as, for example, as a result of inputs received by the individual during execution of a video game, when rendering images as part of a video (e.g., a computer-animated video, etc.), and/or the like. In some embodiments, the computing device 106 can process the input image, can execute the path tracing algorithms, and can apply various screen space effects to enhance the visual quality of the images. The database 108 can store data involved in the execution of at least some of the processes described herein, including scene information, rendering parameters, and intermediate results (e.g., data maintained in a guide buffer that is the same as, or similar to, the guide buffer system 210 of FIG. 2), ensuring that the environment 100 can efficiently manage and retrieve the required information during the path tracing and rendering process. By leveraging the capabilities of these components, the environment 100 can allow for the generation of path-traced images with high fidelity and realism.

Referring now to FIG. 2, illustrated is a workflow 200 for denoising of path traced images with screen space effects, in accordance with some embodiments of the present disclosure. In some embodiments, at least a portion of the workflow 200 is described as being implemented by one or more devices that are the same as, or similar to, those described with respect to FIG. 1. For example, one or more of the functions described with respect to the workflow 200 can be performed (e.g., completely, partially, etc.) by a computing device that is the same as, or similar to, the computing device 106 of FIG. 1. In some embodiments, at least a portion of workflow 200 can be performed (e.g., completely, partially, and/or the like) by another device or a group of devices separate from and/or including the computing device, such as another computing device (e.g., a remote computing device not explicitly illustrated).

As shown in FIG. 2, a rasterized geometry buffer (G-buffer) 204 can be established by the computing device. For example, the rasterized G-buffer 204 can be established and maintained in a database associated with the computing device (e.g., that is the same as, or similar to, the database 108 of FIG. 1) to store geometric information about a scene representing at least a portion of a virtual three-dimensional (3D) environment. In some examples, the rasterized G-buffer 204 can store information about the 3D environment that is used by the computing device to generate a current frame. This information can include, for example, attributes like depth, normal, and material properties established for objects within the 3D environment for one or more (e.g., each) pixel of an image to be rendered of the scene of the environment.

In some embodiments, a path trace lighting system 206 can be configured to obtain the information stored in the rasterized G-buffer 204. For example, the computing device can implement and execute one or more operations associated with the path trace lighting system 206. In this example, the computing device can cause the path trace lighting system 206 to trace paths through the 3D environment to light sources. In some examples, execution of the path trace lighting system 206 can involve sampling the paths in accordance with one or more sampling techniques (e.g., random sampling, etc.). For example, the path trace lighting system 206 can trace rays from a virtual camera through one or more (e.g., each) pixel of an image and into the at least a portion of the 3D environment corresponding to at least the scene. The process can involve generating paths of scattering events that start at the camera and end at light sources in the scene. This method can incrementally generate paths by sampling light interactions at one or more (e.g., each) vertex along the path. The sampling can involve various techniques, such as random sampling, to ensure that the paths cover a wide range of possible light interactions at one or more point along the path. In some embodiments, the path trace lighting system 206 can then generate an input image 202a in response to tracing paths through the 3D environment.

In some embodiments, a screen space effect system 208 can be configured to obtain the input image 202a output by the path trace lighting system 206. For example, the computing device can implement and/or execute one or more operations associated with the screen space effects system 208. In an example, the screen space effects system 208 can obtain the input image 202a to perform one or more operations and apply one or more effects to the input image 202a. These effects can include subsurface scattering, which simulates the way light penetrates and scatters within a translucent object, creating a soft, diffused appearance; refraction, which models the bending of light as it passes through transparent materials like glass or water, altering the appearance of objects seen through them; heat distortion, which mimics the shimmering and warping of light caused by heat waves often seen above hot surfaces; chromatic aberration, which simulates the dispersion of light into its constituent colors, creating a slight color fringing around the edges of objects; depth of field, which blurs parts of an image that are out of focus, mimicking the way a camera lens focuses on a specific plane while other areas remain blurred; bloom, which creates a glowing halo around bright areas of an image, enhancing the perception of brightness and adding a dreamy quality; and/or other effects that can cause the diffusion of noise inherent to the sampling process across the input image 202a, when generating an updated image 202b. In response to execution of the screen space effects system 208, the computing device can generate an updated image 202b. The updated image can be represented by a filter kernel that is applied to at least a subset of the pixels of the input image 202a (e.g., a noisy image I_{before}, also referred to as a noisy image buffer) to generate generating the updated image 202b (e.g., an altered noisy image I_{after}). The screen space effects system 208 can then provide the data associated with the updated image 202b to a guide buffer system 210 to cause the guide buffer system 210 to generate a buffer image 202c, as described herein.

In some embodiments, the guide buffer system 210 can be configured to obtain the input image 202a and the updated image 202b and can generate a buffer image 202c. For example, the computing device can implement and/or execute one or more operations associated with the guide buffer system 210. In an example, the guide buffer system 210 can obtain the input image 202a and the updated image 202b and can calculate a difference(s) between the values associated with one or more pixels of both images. In one example, the guide buffer system 210 can obtain the input image 202a and the updated image 202b and can calculate a luminance difference between the two images for one or more (e.g., each) pixel of the two images. The guide buffer system 210 can then generate a buffer image 202c, based at least on the difference(s) between the input image 202a and the updated image 202b.

In some embodiments, the buffer image 202c can be formed as a tonemapped difference of the buffer after and before the filtering operation: G=h(I_{after}−I_{before}), where h denotes a tonemapping function that handles both positive and negative input values, for example h(x)=sign(x)log(1+c|x|), where c is a constant that represents the frame exposure and brings the guide buffer roughly to an expected range. The buffer image 202c can be computed separately for all the color channels, or to limit bandwidth, it can be computed on the luminance of the RGB color: G=h(L_{after}−L_{before}), where the luminance transform can be for example L=(R+2G+B)/4.

In some embodiments, the computing device can generate a combined image 202d, based at least on the updated image 202b and the buffer image 202c. For example, the computing device can generate a combined image 202d, by concatenating values associated with the pixels represented by the buffer image 202c to the values associated with corresponding pixels in the updated image 202b. In this example, the computing device can generate the combined image 202d, by concatenating the values and adding them as a new channel to the updated image 202b to generate the combined image 202d.

In some embodiments, the denoiser 212 can be configured to obtain the combined image 202d and can execute one or more operations to reduce and/or remove noise from the combined image 202d. For example, the computing device can implement and execute one or more operations associated with the denoiser 212, to remove noise from combined image 202d that has diffused across at least a portion of the updated image 202b image, as a result of the application of the effect by the screen space effects system 208. In one example, the denoiser 212 can implement a neural network to remove noise from the combined image 202d, by employing a denoiser that processes the image data to filter out both spatial and temporal noise introduced during the light path sampling process. This can involve using techniques such as encoder/decoder-based denoiser(s) or transformer-based denoiser(s) to target and eliminate noise, including correlated noise from screen space effects, thereby enhancing the visual quality of the final image. In some embodiments, the denoiser 212 can implement one or more techniques as described in U.S. patent application Ser. No. 19/020,708, filed on Jan. 14, 2025, and titled “Denoising Path-Traced Images Using Transformer Networks,” the contents of which are hereby incorporated by reference in their entirety and for all purposes.

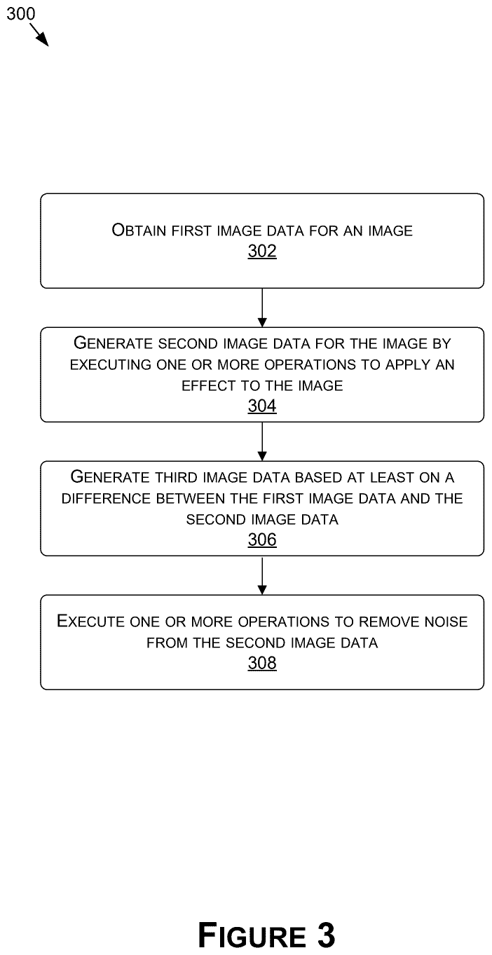

Now referring to FIG. 3, each block of method 300, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (e.g., standalone or in combination with another hosted service), as a microservice, using an application programming interface (API) or a plug-in to another product, to name a few. In addition, method 300 is described, by way of example, with respect to one or more devices that can be the same as, or similar to, those of the environment of FIG. 1. However, this method can additionally, or alternatively, be executed by any one system, or any combination of systems, including, but not limited to, those described herein.

FIG. 3 is a flow diagram, showing a method 300 for denoising of path traced images with screen space effects, in accordance with some embodiments of the present disclosure. The method 300, at block 302, includes obtaining first image data for an image. For example, a computing device (e.g., that is the same as, or similar to, the computing device 106 of FIG. 1 and/or the computing device 500 of FIG. 5) can be configured to execute one or more operations, when performing path tracing to generate an image or series of images. In this example, the computing device can obtain information about one or more attributes of a 3D environment to be used to generate the image and obtain the first image data.

In some embodiments, the computing device can be configured to implement one or more path tracing operations that involve sampling light paths in a scene of a 3D environment, based at least on the information about the attributes of the 3D environment. For example, the computing device can sample the light paths and can trace one or more rays through at least a portion of the environment representing a scene, the rays originating from a camera, passing through an image, and extending through the 3D environment until they reach one or more light sources to obtain the first image data. In this example, the computing device can obtain the first image data in response to the sampling of the light paths in the scene. The first image data can be associated with an amount of noise that was introduced by the sampling. For instance, when the sampling process involves randomly selecting values to determine the pixel values for one or more pixels in an image, the noise level may indicate the inherent uncertainty associated with such random sampling methods.

In some embodiments, the computing device can obtain first image data, where the first image data represents a two-dimensional (2D) image. For example, the computing device can obtain the first image data in response to tracing one or more paths through at least a portion of the environment representing the scene as described above. The first image can be a 2D image with multiple channels representing different aspects of one or more pixels. For instance, the first image may have three channels that represent the red, green, and blue values, which together determine the color displayed at that pixel.

The method 300, at block 304, includes generating second image data for the image, by executing one or more operations to apply an effect(s) to the image. For example, the computing device can generate the second image data, by executing one or more operations to the image associated with the first image data. The one or more operations can result in the application of a screen space effect to the image. For example, the computing device can execute one or more operations, based at least on the first image data to generate the second image data, where the one or more operations results in the application of effects, such as subsurface scatter, refraction, heat distortion, chromatic aberration, depth of field, bloom, etc. As will be understood, the application of screen space effects in rendering offers several benefits that enhance the visual quality and realism of images. But these effects can introduce additional noise that is correlated across multiple pixels, making it challenging for denoisers to remove both the initial noise and the correlated noise.

In some embodiments, the computing device can establish (maintain, update, use) a guide buffer. For example, the computing device can establish a guide buffer, based at least on the first image data and the second image data. In one example, the computing device can establish a guide buffer and maintain a set of values in the guide buffer, representing a difference between the first image data and the second image data. This difference can be associated with a difference in luminance between one or more pixels of the first image and one or more pixels of the second image. In some embodiments, the computing device can maintain the guide buffer as a set of values to be concatenated to the image after one or more effects are applied, where the values are appended as one or more different channels than those found in the image.

The method 300, at block 306, includes generating third image data, based at least on a difference between the first image data and the second image data. For example, the computing device can generate the third image data, based at least on the difference between the first image data and the second image data, as represented in the guide buffer. In some examples, the computing device can then update the second image data based at least on the third image data. In one example, the computing device can update the second image data, by concatenating the values associated with the third image data, as one or more additional channels to the image represented by the second image data (e.g., the image having the one or more effects applied thereto). The computing device can then provide the second image data to a denoiser to cause the denoiser to update the values of one or more of the pixels represented by the second image data to reduce and/or remove the noise introduced by the application of the one or more effects. In one example, the denoiser can include a neural network that is configured to receive the third image data as an input and can generate an output representing the image having at least a portion of the noise removed (also refer to as being denoised).

The method 300, at block 308, includes executing one or more operations to remove noise from the second image data. For example, the computing device can execute one or more operations to remove noise from the second image data. In some embodiments, the denoiser can include a neural network that is configured to denoise images by using an encoder-decoder architecture or any other suitable architecture. In examples where the denoiser uses an encoder-decoder architecture, the neural network can be configured to receive the second image data after the second image data is updated, based at least on the third image data. In these examples, the neural network can provide the second image data as input data to an encoder, causing the encoder to generate output data including and embedding. This embedding can represent the second image data and the third image data (e.g., in a latent space). The neural network can then provide the output data to a decoder to cause the decoder to output a representation of a final image (also referred to as an output image). While the present disclosure is discussed in the context of neural networks that involve encoder-decoder architectures, it will be understood that other neural network-based architectures, such as those involving the use of convolutional neural networks, etc., can be implemented in accordance with the techniques described herein. The computing device can then cause the final image to be displayed on a display device (e.g., a display device that is the same as, or similar to, the display device 104 of FIG. 1) in communication with the computing device.

In some embodiments, the computing device can train and/or update the neural network configured to reduce the noise in the second image. For example, the computing device can provide pairs of noisy images (e.g., that are similar to the image represented by the second image data updated, based at least on the image represented by the third image data) and less noisy images (also referred to as target images) as inputs to the neural network. In some examples, these less noisy images can include images of the same scene, where a greater number of paths are sampled when generating the image (e.g., a higher number of samples per pixel or SPP). The computing device can then compare a difference between the output of the neural network and the target image using loss functions, such as mean squared error or perceptual losses. In some embodiments, approaches can include the use of attention mechanisms, residual connections, etc., to enhance noise reduction. In examples, based at least on the difference between the output of the neural network and the target image, the computing device can update one or more weights of the neural network and iteratively repeat the described process until the difference between the noisy and less noisy images satisfies a threshold value (e.g., the neural network converges). Once trained and/or updated, the network can denoise new images by passing them through this learned pipeline. In some embodiments, the computing device can obtain (e.g., generate) augmented data by replicating screen space effects on the pairs of images as described herein. This approach can allow the training and/or updating process to handle the inherent randomness and improve the robustness of the denoising algorithms. And by augmenting pairs of images as described, the computing device can simulate various noise patterns and enhance the ability of the denoiser 212 to generalize across different scenarios.

The systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments can be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more small language models (SLMs), one or more vision language models (VLMs), one or more multi-modal language models (MMLMs), etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

### Example Language Models

In at least some embodiments, language models, such as large language models (LLMs) and/or other types of generative artificial intelligence (AI) and/or attention-based models can be implemented. For example, hierarchical vision transformer can be implemented in accordance with the principles described herein to reduce noise and/or other defects when reconstructing images generated, based at least on ray tracing, etc., techniques. These models can be capable of understanding, summarizing, translating, and/or otherwise generating text (e.g., natural language text, code, etc.), images, video, computer aided design (CAD) assets, omniverse and/or metaverse file information (e.g., in USD format), and/or the like, based at least on the context provided in input prompts or queries. These language models can be considered “large,” in embodiments, based at least on the models being trained on massive datasets and having architectures with large number of learnable network parameters (weights and biases)—such as millions or billions of parameters. The LLMs/VLMs/etc. can be implemented for summarizing textual data, analyzing and extracting insights from data (e.g., textual, image, video, etc.), and generating new text/image/video/etc. in user-specified styles, tones, and/or formats. The LLMs of the present disclosure can be used exclusively for text processing, in embodiments, whereas in other embodiments, multimodal LLMs can be implemented to accept, understand, and/or generate text along with other types of content like images, audio, and/or video. For example, vision language models (VLMs), or more generally multimodal language models, can be implemented to accept image, video, audio, textual, 3D design (e.g., CAD), and/or other inputs data types and/or to generate or output image, video, audio, textual, 3D design, and/or other output data types.

Various types of LLM/VLM/etc. architectures can be implemented in various embodiments. For example, different architectures can be implemented that use different techniques for understanding and generating outputs—such as text, audio, video, image, etc. In some embodiments, LLM architectures, such as recurrent neural networks (RNNs) or long short-term memory networks (LSTMs) can be used, while in other embodiments transformer architectures—such as those that rely on self-attention mechanisms—can be used to understand and recognize relationships between words or tokens. One or more generative processing pipelines, that include LLMs, can also include one or more diffusion block(s) (e.g., denoisers). The language models of the present disclosure can include encoder and/or decoder block(s). For example, discriminative or encoder-only LLMs like BERT (Bidirectional Encoder Representations from Transformers) can be implemented for tasks that involve language comprehension, such as classification, sentiment analysis, question answering, and named entity recognition. As another example, generative or decoder-only LLMs like GPT (Generative Pretrained Transformer) can be implemented for tasks that involve language and content generation, such as text completion, story generation, and dialogue generation. LLMs that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular embodiment and the task(s) being performed using the model(s).

In various embodiments, the LLMs/VLMs/etc. can be trained using unsupervised learning, in which an LLM learns patterns from large amounts of unlabeled text/audio/video/image/etc. data. Due to the extensive training, in embodiments, the models cannot require task-specific or domain-specific training. LLMs that have undergone extensive pre-training on vast amounts of unlabeled text data can be referred to as foundation models and can be adept at a variety of tasks like question-answering, summarization, filling in missing information, and translation. Some LLMs can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure can be implemented using various model alignment techniques. For example, in some embodiments, guardrails can be implemented to identify improper or undesired inputs (e.g., prompts) and/or outputs of the models. In some non-limiting embodiments, the guardrails implemented can be similar to those described in U.S. Pat. App. No. 18,304,341, filed on Apr. 20, 2023, the contents of which are hereby incorporated by reference in their entirety. In some embodiments, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/etc. of the present disclosure can be less likely to output language/text/audio/etc. that can be offensive, vulgar, improper, unsafe, out of domain, and/or otherwise undesired for the particular application/implementation.

In some embodiments, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based at least on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., using one or more APIs) to retrieve the relevant information. As another example, where at least part of a response requires a mathematical computation, the model can access one or more math plug-ins or APIs for help in solving the problem(s) and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some embodiments, multiple language models (e.g., LLMs/VLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.), to provide output responsive to the same query, or responsive to separate portions of a query. In at least one embodiment, multiple language models e.g., language models with different architectures, language models trained on different (e.g., updated) corpuses of data can be provided with the same input query and prompt (e.g., set of constraints, conditioners, etc.). In one or more embodiments, the language models can be different versions of the same foundation model. In one or more embodiments, at least one language model can be instantiated as multiple agents—e.g., more than one prompt can be provided to constrain, direct, or otherwise influence a style, a content, or a character, etc., of the output provided. In one or more example, non-limiting embodiments, the same language model can be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more embodiments, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 430. In some embodiments, the input 401, includes plain text in the form of one or more sentences, paragraphs, and/or documents. Additionally or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multimodal inputs, the input 401 can combine text with image data, audio data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some embodiments, a RAG component 492 can be used to retrieve additional information to be used as part of the input 401 or prompt. For example, in some embodiments, the input 401 can be generated using the query or input to the model (e.g., a question, a request, etc.), in addition to data retrieved using the RAG component 492. In some embodiments, the input processor 405 can analyze the input 401 and communicate with the RAG component 492 (or the RAG component 492 can be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The tokenizer 410 can segment the (e.g., processed) text into smaller units (tokens) for subsequent analysis and processing. The tokens can represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors, such as the language being processed, the task at hand, and/or characteristics of the training dataset. As such, the tokenizer 410 can convert the (e.g., processed) text into a structured format according to tokenization schema being implemented in the particular embodiment.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data, the input processor 405 can resize the image data to a standard size compatible with format of a corresponding input channel and/or can normalize pixel values to a common range (e.g., 0 to 1), to ensure a consistent representation, and the embedding component 420 can encode the image data using any known technique (e.g., using one or more convolutional neural networks (CNNs) to extract visual features). In some implementations in which the input 401 includes audio data, the input processor 405 can resample an audio file to a consistent sampling rate for uniform processing, and the embedding component 420 can use any known technique to extract and encode audio features—such as in the form of a spectrogram (e.g., a mel-spectrogram). In some implementations in which the input 401 includes video data, the input processor 405 can extract frames or apply resizing to extracted frames, and the embedding component 420 can extract features such as optical flow embeddings or video embeddings and/or can encode temporal information or sequences of frames. In some implementations in which the input 401 includes multimodal data, the embedding component 420 can fuse representations of the different types of data (e.g., text, image, audio) using techniques like early fusion (concatenation), late fusion (sequential processing), attention-based fusion, etc.

The generative LM 430 and/or other components of the generative language model system 400 can use different types of neural network architectures depending on the implementation. For example, transformer-based architectures, such as those used in models like GPT, can be implemented, and can include self-attention mechanisms that weigh the importance of different words or tokens in the input sequence and/or feedforward networks that process the output of the self-attention layers, applying non-linear transformations to the input representations, and extracting higher-level features. Some non-limiting example architectures, include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some embodiments, the generative LM 430 can be configured to access or use—or capable of accessing or using—plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based at least on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model can access one or more restaurant or weather plug-ins (e.g., using one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation, in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens, by taking the dot product of the query vector with the corresponding key vectors, normalizing the resulting scores, multiplying by corresponding value vectors, and summing weighted value vectors. The encoder can apply multi-headed attention, in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence, by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier, comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token, based at least on a corresponding predicted probability (e.g., select the word with the highest predicted probability), and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B, except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token, based at least on a corresponding predicted probability, and appending it to the output from a previous pass, generating each token sequentially until selecting or sampling a symbol or token that represents the end of the response. These, and other architectures described herein, are meant simply as examples, and other suitable architectures can be implemented within the scope of the present disclosure.

### Example Computing Device

FIG. 5 is a block diagram of an example computing device(s) 500 suitable for use in implementing some embodiments of the present disclosure (e.g., as the computing device 106 and/or the computing device described in accordance with the workflow 200 of FIG. 2). Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected using the interconnect system 502 with lines, this is not intended to be limiting and is for clarity only. For example, in some embodiments, a presentation component 518, such as a display device, can be considered an I/O component 514 (e.g., if the display is a touch screen). As another example, the CPUs 506 and/or GPUs 508 can include memory (e.g., the memory 504 can be representative of a storage device, in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information, such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information, and which can be accessed by computing device 500. As used herein, computer storage media does not comprise signals per se.

The computer storage media can embody computer-readable instructions, data structures, program modules, and/or other data types in a modulated data signal, such as a carrier wave or other transport mechanism, and includes any information delivery media. The term “modulated data signal” can refer to a signal that has one or more of its characteristics set or changed in such a manner as to encode information in the signal. By way of example, and not limitation, the computer storage media can include wired media, such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented, using Complex Instruction Set Computing (CISC). The computing device 500 can include one or more CPUs 506, in addition to one or more microprocessors or supplementary co-processors, such as math co-processors.

In addition to, or alternatively, from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In embodiments, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received using a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., using a link). The link can directly connect the GPUs (e.g., using NVLINK) or can connect the GPUs through a switch (e.g., using NVSwitch). When combined together, each GPU 508 can generate pixel data, or GPGPU data, for different portions of an output or for different outputs (e.g., a first GPU for a first image and a second GPU for a second image). Each GPU can include its own memory or can share memory with other GPUs.

In addition to, or alternatively, from the CPU(s) 506 and/or the GPU(s) 508, the logic unit(s) 520 can be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 can discretely or jointly perform any combination of the methods, processes, and/or portions thereof. One or more of the logic units 520 can be part of and/or integrated in one or more of the CPU(s) 506 and/or the GPU(s) 508, and/or one or more of the logic units 520 can be discrete components or otherwise external to the CPU(s) 506 and/or the GPU(s) 508. In embodiments, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices using an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices, including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one embodiments of the present disclosure. The data center 600 can include a data center infrastructure layer 610, a framework layer 620, a software layer 630, and/or an application layer 640. The data center 600 can be used to implement some and/or all of the operations described with respect to the environment 100 of FIG. 1, the workflow 200 of FIG. 2, etc.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one embodiment, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) can correspond to a server having one or more of the above-mentioned computing resources. In addition, in some embodiments, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one embodiment, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory, or storage resources that can be configured or allocated to support one or more workloads. In at least one embodiment, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one embodiment, resource orchestrator 612 can include a software design infrastructure (SDI) management entity for the data center 600. The resource orchestrator 612 can include hardware, software, or some combination thereof.

In at least one embodiment, as shown in FIG. 6, framework layer 620 can include a job scheduler 628, a configuration manager 634, a resource manager 636, and/or a distributed file system 638. The framework layer 620 can include a framework to software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one embodiment, job scheduler 628 can include a Spark driver to facilitate scheduling of workloads supported by various layers of data center 600. The configuration manager 634 can be capable of configuring different layers, such as software layer 630 and framework layer 620, including Spark and distributed file system 638 for supporting large-scale data processing. The resource manager 636 can be capable of managing clustered or grouped computing resources mapped to or allocated for support of distributed file system 638 and job scheduler 628. In at least one embodiment, clustered or grouped computing resources can include grouped computing resource 614 at data center infrastructure layer 610. The resource manager 636 can coordinate with resource orchestrator 612 to manage these mapped or allocated computing resources.

In at least one embodiment, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one embodiment, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 can implement any number and type of self-modifying actions, based at least on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software, or other resources to train one or more machine learning models or predict or infer information using one or more machine learning models according to one or more embodiments described herein. For example, a machine learning model(s) can be trained by calculating weight parameters according to a neural network architecture, using software and/or computing resources described above, with respect to the data center 600. In at least one embodiment, trained or deployed machine learning models corresponding to one or more neural networks can be used to infer or predict information, using resources described above, with respect to the data center 600 by using weight parameters calculated through one or more training techniques, such as but not limited to those described herein.

In at least one embodiment, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 800 of FIG. 8—e.g., each device can include similar components, features, and/or functionality of the computing device(s) 800. In addition, where backend devices (e.g., servers, NAS, etc.) are implemented, the backend devices can be included as part of a data center 600, an example of which is described in more detail herein with respect to FIG. 6.

Components of a network environment can communicate with each other using a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein, with respect to a server(s), can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications using one or more application programming interfaces (APIs)). The framework layer can be, but is not limited to, a type of free and open-source software web application framework, such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 800 described herein with respect to FIG. 8. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain first image data of an image generated in accordance with one or more path tracing operations;
generate second image data of the image by executing one or more operations to apply a screen space effect to the image;
generate third image data based at least on a difference between the first image data and the second image data; and
execute one or more operations to remove noise from the second image data based at least on the second image data and the third image data.

2. The one or more processors of claim 1, wherein the one or more path tracing operations comprise sampling light paths in a scene from a camera through to a light source, and
wherein, to obtain the first image data, the one or more circuits are to:
obtain the first image data in response to sampling at least one of the light paths in the scene, wherein the first image data is associated with an amount of noise introduced by the sampling.

3. The one or more processors of claim 2, wherein the image comprises a two-dimensional image, and
wherein, to generate the second image data, the one or more circuits are to execute the one or more operations to the image to apply the screen space effect to the image.

4. The one or more processors of claim 1, wherein the one or more circuits are to establish a guide buffer based at least on the first image data and the second image data, the guide buffer comprising one or more values representing the difference between the first image data and the second image data.

5. The one or more processors of claim 4, wherein, to establish the guide buffer, the one or more circuits are to determine the one or more values representing the difference between the first image data and the second image data using a channel of the image corresponding to luminance of pixels of the image.

6. The one or more processors of claim 4, wherein, to generate third image data, the one or more circuits are to update the second image data by concatenating the values in the guide buffer as one or more additional channels to generate the third image data.

7. The one or more processors of claim 1, wherein to execute the one or more operations to remove noise from the second image data, the one or more circuits are to:
generate input data based at least on the second image data and the third image data;
provide the input data to an encoder to generate output data comprising an embedding that represents the second image data and the third image data; and
provide the output data to a decoder to generate a final image.

8. The one or more processors of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing small language models (SLMs);
a system for implementing large language models (LLMs);
a system for implementing multi-modal language models (MMLMs);
a system for hosting one or more real-time streaming applications;
a system for performing light transport simulation;
a system using or deploying one or more inference microservices;
a system that incorporates one or more machine learning models deployed in a service or microservice along with an OS-level virtualization package (e.g., a container);
a system for performing collaborative content creation for 3D assets; or
a system implemented at least partially using cloud computing resources.

9. A system comprising:
one or more processors to perform operations comprising:
executing one or more operations to apply a screen space effect to first image data for an image generated in accordance with one or more path tracing operations to obtain second image data for the image;
generating third image data based at least on a difference between the first image data and the second image data; and
executing one or more operations to remove noise from the second image data based at least on the second image data and the third image data.

10. The system of claim 9, wherein the one or more path tracing operations comprise sampling light paths in a scene from a camera through to a light source, and
wherein the one or more processors are to:
obtain the first image data in response to sampling of at least one of the light paths in the scene, wherein the first image data is associated with an amount of noise introduced by the sampling.

11. The system of claim 10, wherein the image comprises a two-dimensional image, and wherein the screen space effect comprises at least one of:
subsurface scatter;
refraction;
heat distortion;
chromatic aberration;
depth of field; or
bloom.

12. The system of claim 9, wherein the one or more processors are to update a guide buffer based at least on the first image data and the second image data, the guide buffer comprising one or more values representing the difference between the first image data and the second image data.

13. The system of claim 12, wherein, to update the guide buffer, the one or more processors are to determine the one or more values representing the difference between the first image data and the second image data using a channel of the image corresponding to luminance of pixels of the image.

14. The system of claim 12, wherein, to generate third image data, the one or more processors are to update the second image data by concatenating the values in the guide buffer as one or more additional channels to generate the third image data.

15. The system of claim 9, wherein to execute the one or more operations to remove noise from the second image data, the one or more processors are to:
generate input data based at least on the second image data and the third image data;
provide the input data to an encoder to generate output data comprising an embedding that represents the second image data and the third image data; and
provide the output data to a decoder to generate a final image.

16. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more small language models (SLMs);
a system implementing one or more large language models (LLMs);
a system implementing one or more vision language models (VLMs);
a system for implementing multi-modal language models (MMLMs);
a system for generating synthetic data;
a system for generating synthetic data using AI;
a system incorporating one or more virtual machines (VMs);
a system implemented at least partially in a data center;
a system using or deploying one or more inference microservices;
a system that incorporates one or more machine learning models deployed in a service or microservice along with an OS-level virtualization package (e.g., a container);
or
a system implemented at least partially using cloud computing resources.

17. A method comprising:
executing one or more operations to apply a screen space effect to first image data for an image generated in accordance with one or more path tracing operations to obtain second image data for the image;
updating a guide buffer based at least on a difference between the first image data and the second image data; and
executing one or more operations to remove noise from the second image data using at least the guide buffer.

18. The method of claim 17, wherein the one or more path tracing operations comprise sampling light paths in a scene from a camera through to a light source, and
further comprising:
obtaining the first image data in response to sampling of at least one of the light paths in the scene, wherein the first image data is associated with an amount of noise introduced by the sampling.

19. The method of claim 18, wherein the image comprises a two-dimensional image, and wherein the screen space effect comprises at least one of:
subsurface scatter;
refraction;
heat distortion;
chromatic aberration;
depth of field; or
bloom.

20. The method of claim 17, further comprising:
maintaining the guide buffer based at least on the first image data and the second image data, the guide buffer comprising one or more values representing the difference between the first image data and the second image data.
